(19) United States
(12) Patent Application Publication
(10) Pub. No.: US 2009/0100243 A1
(43) Pub. Date: Apr. 16, 2009

(54) High Performance, Lock-Free Virtual Storage Manager

(75) Inventors: Donald F. Ault, Hyde Park, NY (US); Peter J. Relson, Ulster Park, NY (US); James H. Mulder, Wappingers Falls, NY (US); Elpida Tzortzatos, Lagrangeville, NY (US); Paula M. Spens, Poughkeepsie, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/872,821

(22) Filed: Oct. 16, 2007

(51) Int. Cl. G06F 12/02

(52) U.S. Cl. 711/170; 711/E12.002; 711/E12.084

(57) ABSTRACT

A virtual storage technique is provided to manage a cell pool or a set of cell pools which can be used to satisfy variable-size storage requests. The algorithm uses no locks and relies on an atomic compare-and-swap instruction to serialize updates to the fields that can be simultaneously requested by multiple threads or processes. A free chain is used to manage cells which have already been obtained and freed, while there is an active extent that is used to hand out cells which have not previously been obtained. The algorithm is based on all cell pool extents being the same size, which allows the control information for the extent to be easily located on the extent boundary (e.g. at a 1 MB boundary). Control information for each cell is stored independently of the cell storage in a control array that resides at the head of the extent, along with other control information. This avoids cell overrun from damaging the cell pool control information. The result is a high performance storage manager with good serviceability characteristics.

### BACKGROUND OF THE INVENTION

1. Field of the Invention

This invention relates to a method and apparatus for managing virtual storage in a computing system.

2. Description of the Related Art

Virtual storage is a well-known computing concept whereby programs use “virtual” memory addresses rather than real addresses in physical storage. Typically, a set of dynamic address translation (DAT) tables maintained by a computer operating system for a particular virtual “address space” map pages of virtual memory—typically, 4096-byte blocks of contiguous memory addresses—to corresponding real pages in physical memory. Whenever a program instruction references a page in virtual memory, the central processing unit (CPU) uses the DAT tables to generate the correct real storage address. (Virtual pages can also be swapped out to disk storage, in which case an attempted access results in a “page fault” requiring a disk access to retrieve the page.) Virtualizing storage addresses in this manner frees applications and other programs from the task of memory management, so that such programs can reference a virtual memory address without having to concern themselves with where (or even whether) the data resides in real storage.

Ever since virtual storage has been used, there has been a need to manage it. Thus, programs need a mechanism for obtaining blocks of virtual storage for their use as well as for returning blocks of storage that are no longer needed. There have been many solutions created to manage virtual storage for the operating system and for applications. Some of these services are very robust. Usually the more robust the service, the higher the cost in CPU instructions it takes to obtain and free a piece of storage. When the path length or serialization of the robust service becomes too high, lower-level system components or applications are forced to obtain large areas of storage, which are then managed to hand out smaller subsets of virtual storage. In this micromanagement of the larger storage area, there have been multiple solutions. On the IBM z/OS operating system, these solutions have included the following:
1. GETMAIN and STORAGE OBTAIN services get system locks to serialize access to private or common storage. GETMAIN is described at pages 621-634 of the IBM publication MVS Programming: Assembler Services Reference, Volume 1 (ABEND-HSPSERV), SA22-7606-08 (September 2006), while STORAGE OBTAIN is described at pages 107-128 of the IBM publication MVS Programming: Authorized Assembler Services Reference, Volume 4 (SETFRR-WTOR), SA22-7612-09 (September 2007), both of which are incorporated herein by reference. GETMAIN and STORAGE OBTAIN use a series of control blocks accessible by the operating system to keep track of what storage is allocated and what is free. While these services do not suffer from user overlays damaging the control information, they are not without their problems. Primarily, the “path length” to get and free storage is too high, and the locks used to serialize the storage management become bottlenecks in systems with frequent requests for storage.
2. In another approach, CPOOL (cell pool) services are used to carve up a large area into equal-size cells. These cells are then chained up. Requests for a new cell use compare-and-swap logic to take a first cell off a free chain. Free requests use compare-and-swap to place the cells back on the free chain. When the pool runs out of cells, there is serialized logic to get a new extent and chain up a bunch of new cells. This approach has several problems. For each extent, the cells are prechained, requiring that a real page back a virtual page in order to store the pointer and thereby causing all of the pages of an extent to be backed in real storage long before they are needed. This can cause the cells to eventually be paged out to secondary storage, forcing them to be paged back in when eventually needed. Also, when the cells are on a free chain, the first bytes of the cell are used as a pointer to the next cell. If a user of the previous cell overruns the end of the cell, the free chain is damaged and the problems caused by this can cause a system outage. Finally, there is no easy way to detect whether a cell is being freed when already on the free chain (double free).
3. Commonly owned U.S. Pat. No. 6,065,019 (Ault et al.), incorporated herein by reference, describes a “heap pools” approach. This approach manages a large block of storage by carving it into cells, similar to the CPOOL approach described above. It does not prechain the cells. Instead, it manages the cells in two ways. There is a free chain of cells, which consists of cells that have been returned to the pool. When a cell is needed and the free chain is empty, a new cell is obtained from the active extent by using a compare and swap to move a “high water” mark (HWM) to the next cell in the extent. When a new extent is needed, potentially multiple work units will get a new extent and attempt to make it active with compare and swap. The loser frees the new extent. This approach as well has its problems. When the cells are on the free chain, the first bytes of the cell are used as a pointer to the next cell. If a user of the previous cell overruns the end of the cell, the free chain is damaged and the problems caused by this can cause a system outage. Also, there is no easy way to detect whether a cell is being freed when already on the free chain.

In C and C++ programming environments, applications obtain areas of virtual storage by calling malloc( ) or new( ). The C runtime library manages a large area of storage called the heap, where these storage requests are satisfied from. This heap is typically managed with a binary tree that keeps track of freed areas of storage. The tree is typically serialized by a lock or mutex. This approach too has its problems. In a heavily multithreaded environment, the mutex becomes a severe bottleneck in the processing across multiple threads. Also, the storage returned to the caller typically has a prefix area on it, containing the size of the storage area. This prefix can be overrun and damage the tree.

### BRIEF SUMMARY OF THE INVENTION

The present invention contemplates a method, apparatus and computer program product for managing virtual storage. In accordance with the invention, there is maintained in virtual storage a cell pool extent comprising a control array in a first portion thereof and a cell array in a second portion thereof. The cell array comprises one or more cells of available storage, while the control array contains one or more control array elements corresponding respectively to the cells. Each of the control array elements indicates whether a corresponding cell is currently allocated to a requester. In response to a request from a requester to obtain a cell of storage, a cell is allocated from the cell array to the requester, and the corresponding control array element is updated to indicate that the cell is currently allocated to a requester.

In a preferred embodiment, the cell pool extent contains a header with pointers to the control array and to the cell array, while one or more of the control array elements contain a pointer to a next control array element in a chain of control array elements corresponding to free cells. The cell pool extent preferably contains one or more previously unallocated cells and a pointer to one or more free cells that have been returned by requesters; a free cell is allocated if one is available, otherwise, a previously unallocated cell is allocated. To accomplish this, the cell pool extent contains a pointer to a control array element corresponding to one of the free cells, as well as a pointer to a control array element corresponding to one of the previously unallocated cells. A free cell is allocated by updating the pointer to point to a control array element corresponding to a next one of the free cells, while, similarly, a previously unallocated cell is allocated by updating the pointer to point to a control array element corresponding to a next one of the previously unallocated cells. If there are no cells available for allocation from a currently active extent, then a new extent is created and a cell is allocated from the new extent. Preferably, the pointer manipulations for a particular cell allocation are performed using a single atomic instruction, such as a compare-and-swap instruction, to avoid the necessity for obtaining a lock.

In response to a request to return a cell of storage, the corresponding control array element is examined to determine whether the cell is currently allocated to a requester. If the control array element indicates that the cell is currently allocated to a requester, the cell is returned to the cell array and the corresponding control area element is updated to indicate that the cell is not currently allocated to a requester. Otherwise, the request is failed without updating the corresponding control area element. To accomplish this in a preferred embodiment, the cell pool extent contains a pointer (such as the one mentioned above) to a control array element corresponding to one of the free cells; a cell is returned to the array by updating the pointer to point to a control array element corresponding to the returned cell.

Preferably, the cell pool extent has a base address located at a multiple of a predetermined storage increment, while each cell pool extent has a common size if there is more than one cell pool extent. When returning a cell, the request to return the cell contains the cell address of the cell to be returned. This permits the base address of the cell pool extent to be determined from the cell address by rounding the cell address down to a multiple of the storage increment.

A plurality of sets of cell pool extents may be maintained in virtual storage, with the cell pool extents in each of the sets containing cells of a given size. In such a case, the allocation is performed by allocating a cell of the smallest size sufficient to satisfy the request.

To summarize, this invention is based on the heap pools approach, where there is a free chain and a high water mark in the active extent for each cell size. A significant difference is that all extents are preferably a fixed size—e.g., 1 megabyte (MB). Each extent has a control array in the front and a cell array filling most of the extent. The control array and cell array are the same dimension, with control array element 1 controlling cell array element 1 and so on for each corresponding pair of array elements. The control array elements for free cells are chained, which keeps the chain pointers outside of the user cells, making them less likely to be overlaid. Freeing a cell requires just the cell address, which is used to locate the control array element in the front of the extent. This solution retains the lock-free feature of the heap pools approach and solves the problems of control information overlay and double free of cells.

Users can build and use a cell pool that contains cells that are all the same size. To support variable-size virtual storage requests, the system provides a front end which matches the user's requested storage size to an appropriate cell pool. Once the appropriate cell pool is chosen, the processing is the same as for a single-size cell pool.

This method uses atomic instructions during GET and FREE requests, thereby avoiding the need for locks. The separation of control information from user storage reduces the risk of storage overruns damaging the control structures used to manage the storage.

The method and apparatus of the present invention are preferably implemented using a hardware machine in combination with computer software running on that machine. The software portion of such an implementation contains means or logic in the form of a program of instructions that are executable by the hardware machine to perform the method steps of the invention. The program of instructions may be embodied on a program storage device comprising one or more volumes using semiconductor, magnetic, optical or other storage technology.

### BRIEF DESCRIPTION OF THE SEVERAL VIEWS OF THE DRAWINGS

FIG. 1A shows a computer system incorporating the present invention.

FIG. 1B shows a map of virtual storage.

FIG. 2 shows a map of a single extent in a cell pool.

FIG. 3A shows a map of the control area in an extent.

FIG. 3B shows a free cell chain.

FIG. 4 shows a flow diagram for the cell pool build operation.

FIG. 5 shows a flow diagram for the cell pool get service.

FIG. 6 shows a flow diagram of the expand pool routine which gets a new extent.

FIG. 7 shows a flow diagram for the cell pool free service.

FIG. 8 shows the control structures supporting multiple cells pools that support a variable-size request for storage.

FIG. 9 shows a flow diagram for a variable-size storage request.

### DETAILED DESCRIPTION OF THE INVENTION

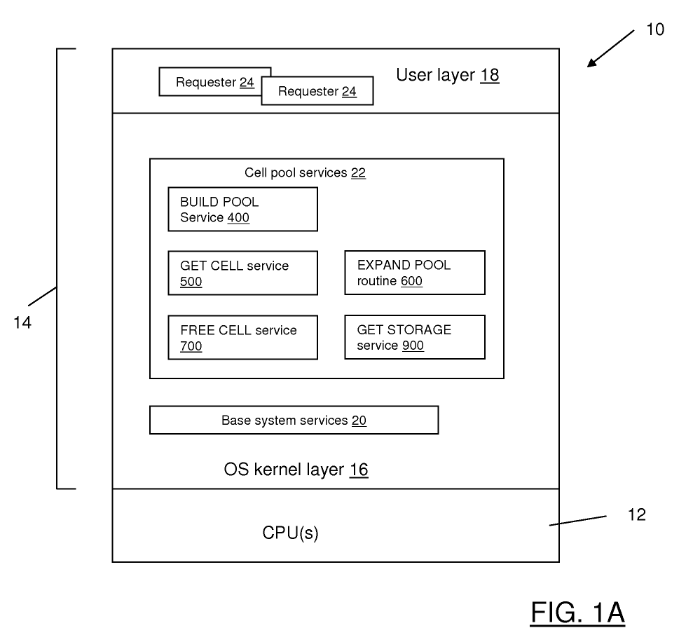

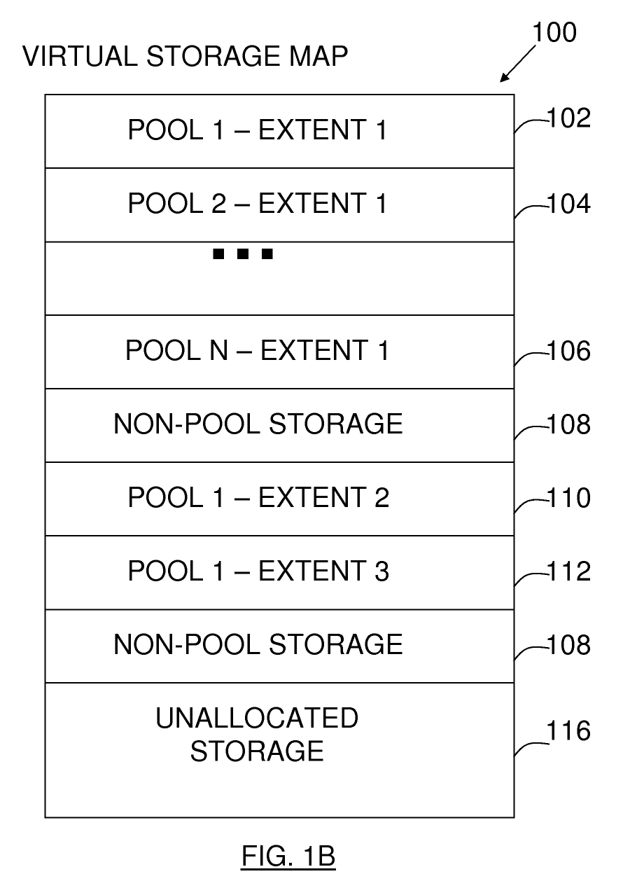

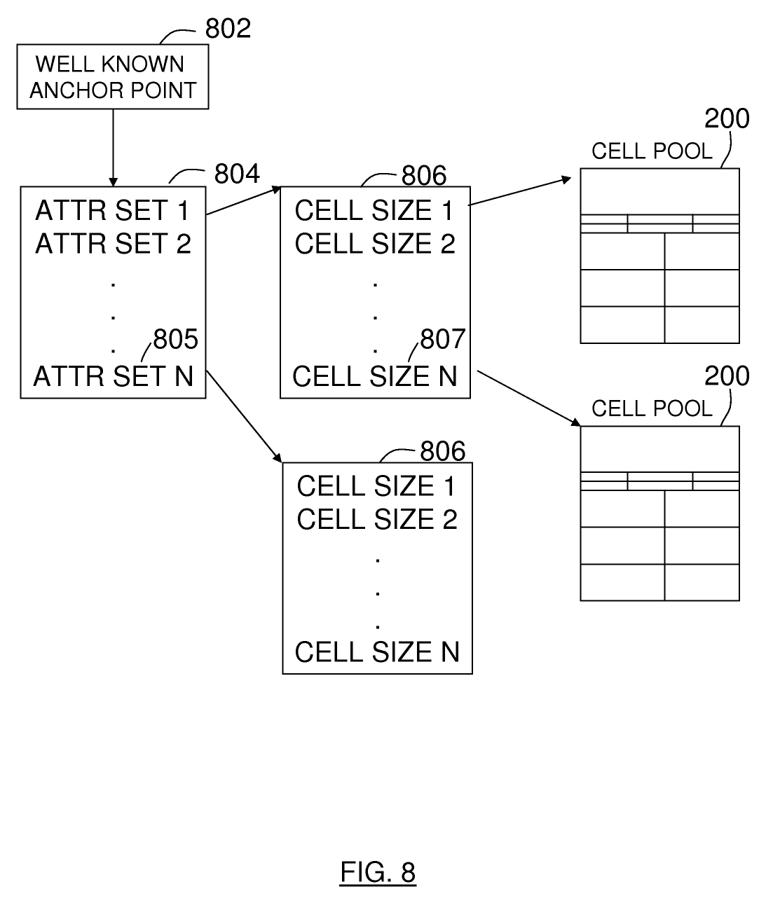

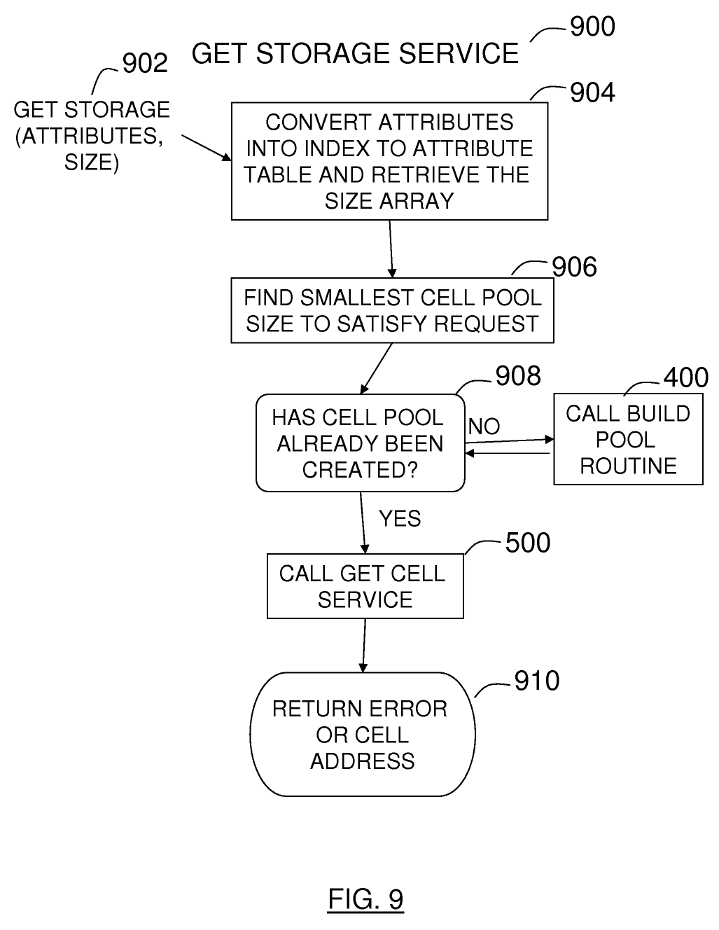

The present invention will be described in two phases. The first phase (FIGS. 1A-7) will describe the processing to create and manage a cell pool for a fixed-size cell. The second phase (FIGS. 8-9) will show how to use multiple cell pools to provide support for variable-size storage requests.

FIG. 1A shows a computer system 10 incorporating the present invention. System 10, which may be either a client or a server, may comprise a separate physical machine, a separate logical partition of a logically partitioned machine, or a guest machine running on a virtualization layer of an underlying physical machine. System 10 contains at least one CPU 12 and main memory 14, as well as an input/output (I/O) system for connection to nonvolatile disk storage and other peripheral devices. (Since the I/O system and the peripheral devices function conventionally in the present invention, they have not been shown.) Loaded into main memory 14 from storage and executing on CPU 12 are one or more programs in an operating system (OS) kernel layer 16 as well as a user layer 18. While the present invention is not limited to any particular hardware or software platform, an exemplary system 10 comprises an IBM System z server having a version of the IBM z/OS operating system running on a z/Architecture processor.

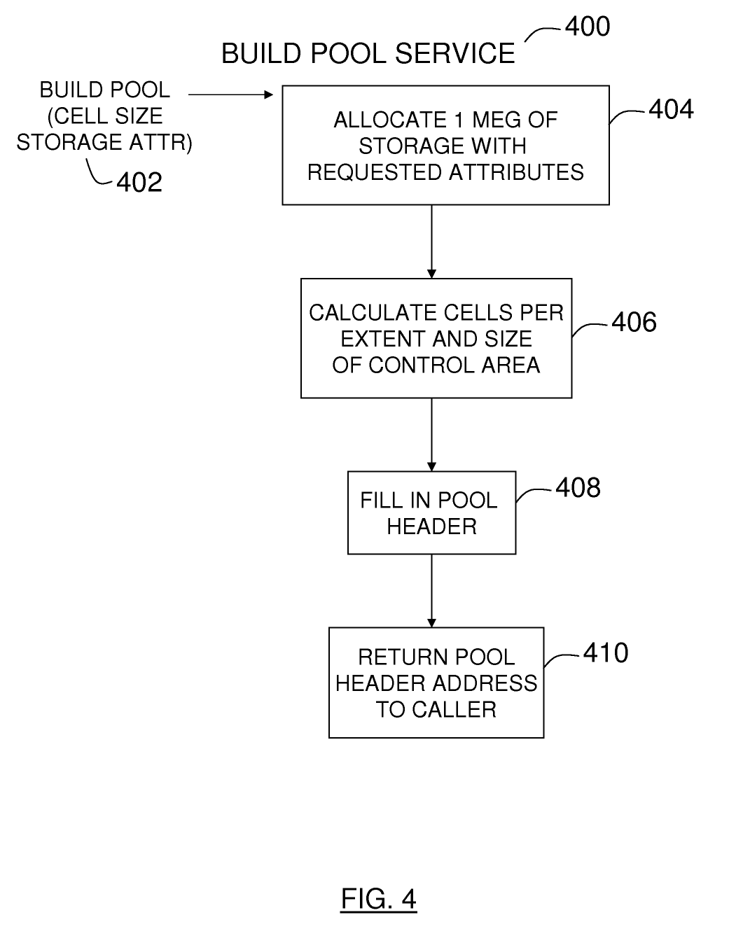

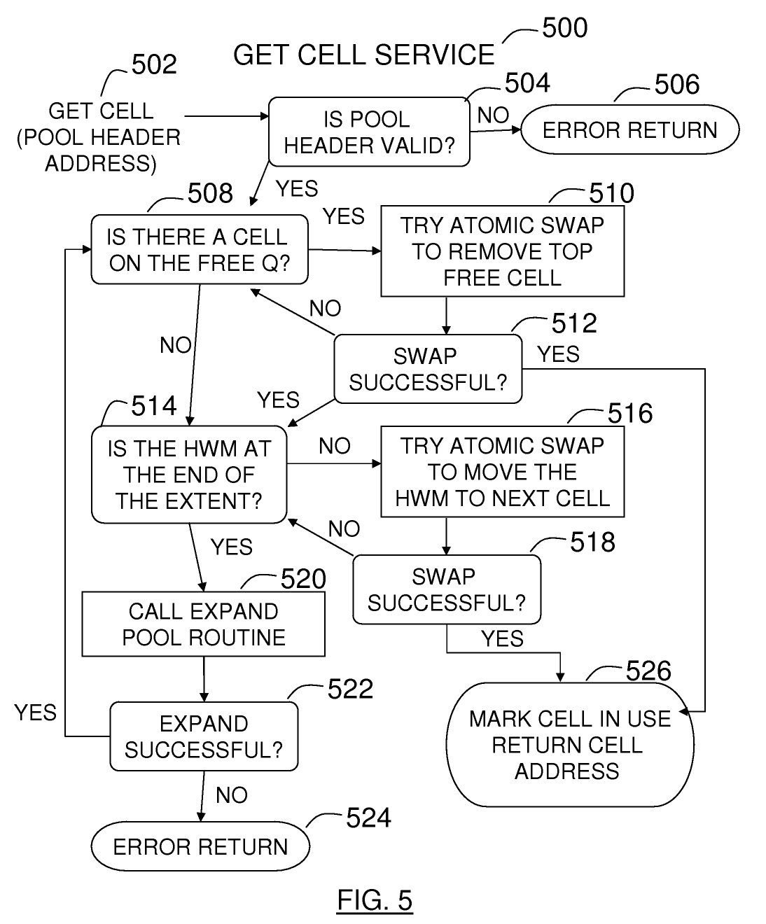

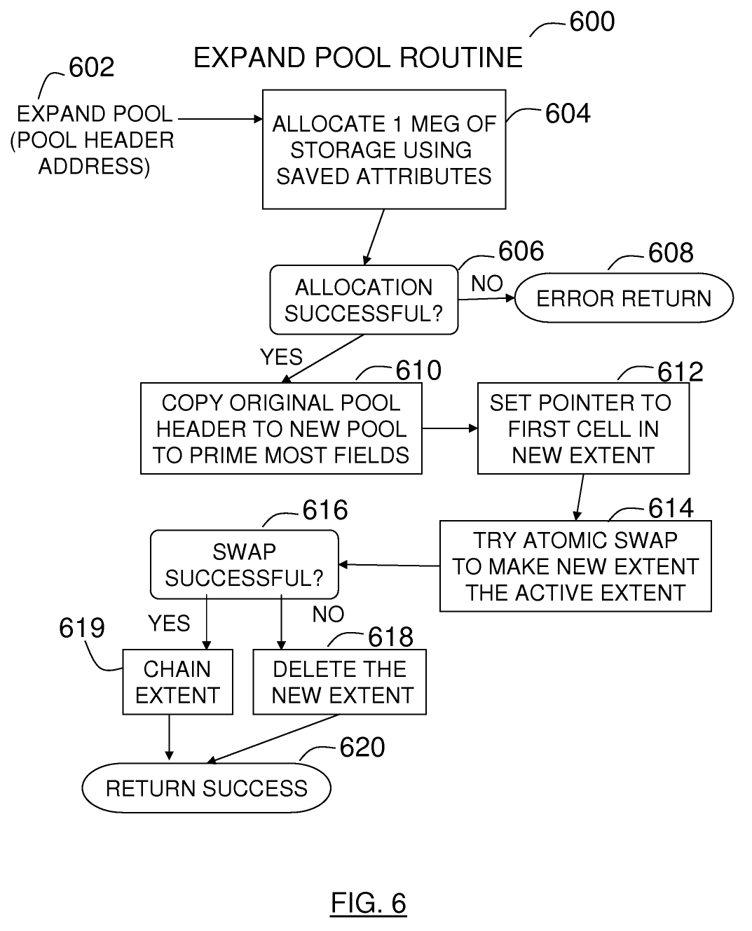

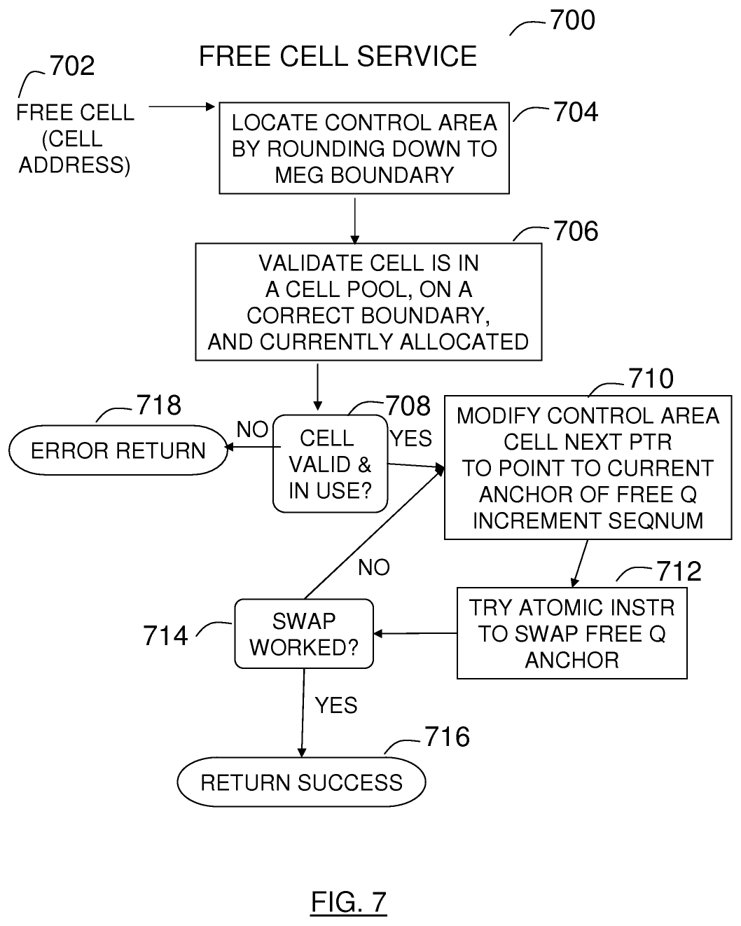

OS kernel layer 16 contains base system services 20, which are conventional in their operation, as well as the cell pool services 22 of the present invention. Cell pool services 22 call upon base system services 20 as necessary and are themselves called upon by requesters 24. Requesters 24 are programs or processes that typically reside in the user layer 18, but may reside in the OS kernel layer 18 as well. Cell pool services 22, to be described further below, include a BUILD POOL service 400 (FIG. 4), a GET CELL service 500 (FIG. 5), a FREE CELL service 700 (FIG. 7), and a GET STORAGE service 900 (FIG. 9). Also associated with cell pool services 22 is an EXPAND POOL routine 600 (FIG. 6) which is called by the GET CELL service 500 rather than by any requester 24 directly.

FIG. 1B shows a virtual storage map 100 representing contiguous locations in virtual storage for computer system 10. The figure shows that storage for cell pool 1 has an initial extent 102 (extent 1) and secondary extents 110 and 112 (extents 2 and 3), while cell pool 2 has but one extent 104 (extent 1) and cell pool N has but one extent 106 (extent 1). There is also non-pool storage 108 that has been allocated by means other than cell pool services 22, as well as unallocated storage 116.

The cell pool services 22 of the present invention use base system services 20 for allocating a large area of memory. These base system services 20 could be malloc( ) or new( ) for a C program, GETMAIN on an IBM z/OS operating system, or any other service that allows the system or application to obtain virtual storage. GETMAIN is described in the IBM publication SA22-7606-08 identified above, while malloc( ) is described at pages 1172-1173 of the IBM publication XL C/C++ Run-Time Library Reference, SA22-7821-09 (September 2007). The cell pool services 22 then micromanage this storage to provide their callers with smaller pieces of virtual storage.

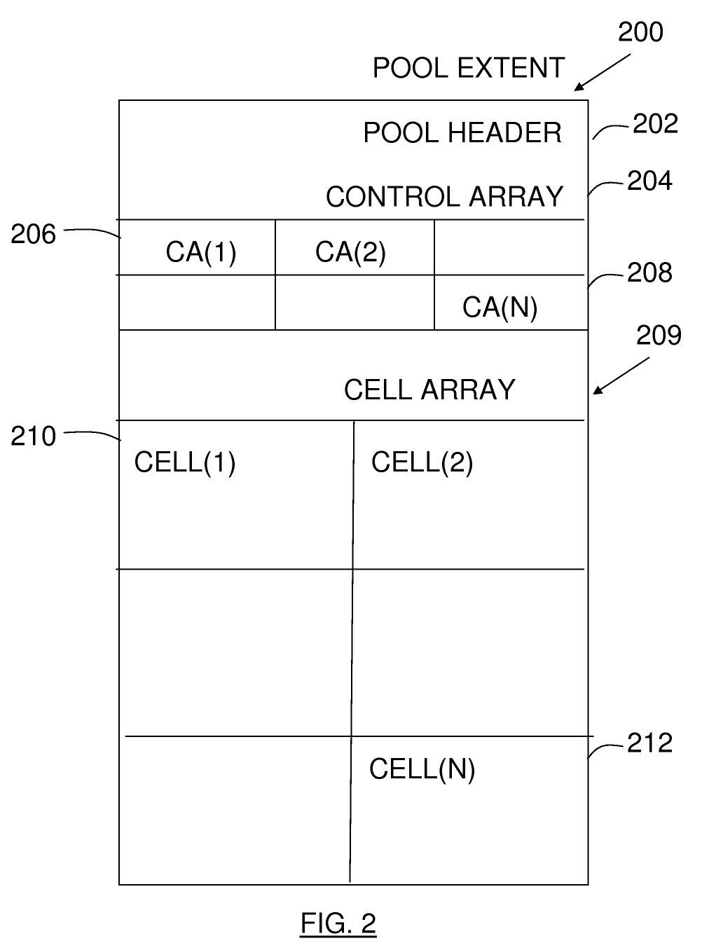

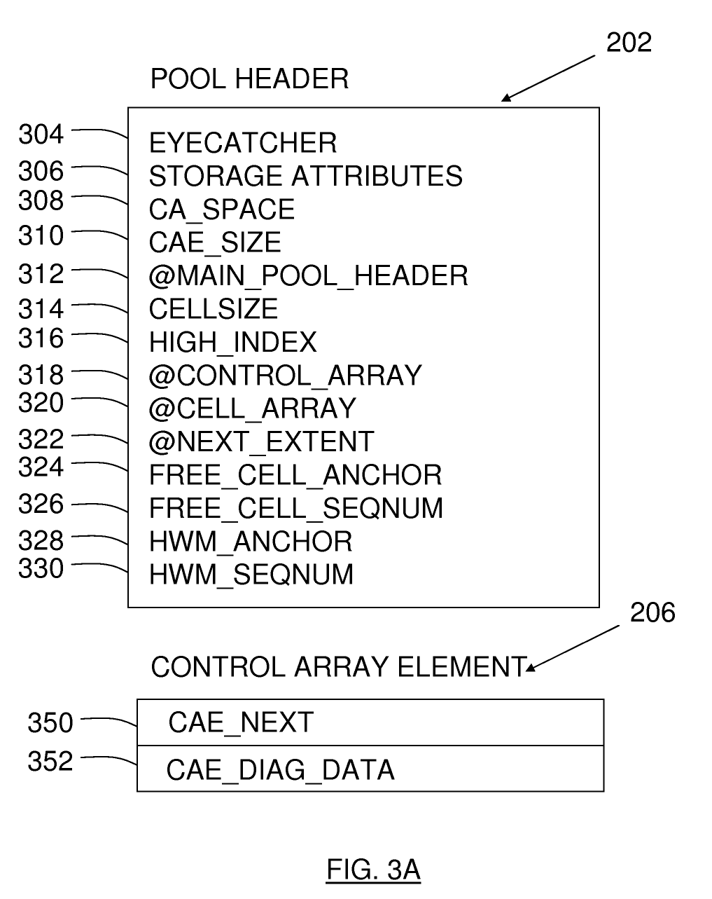

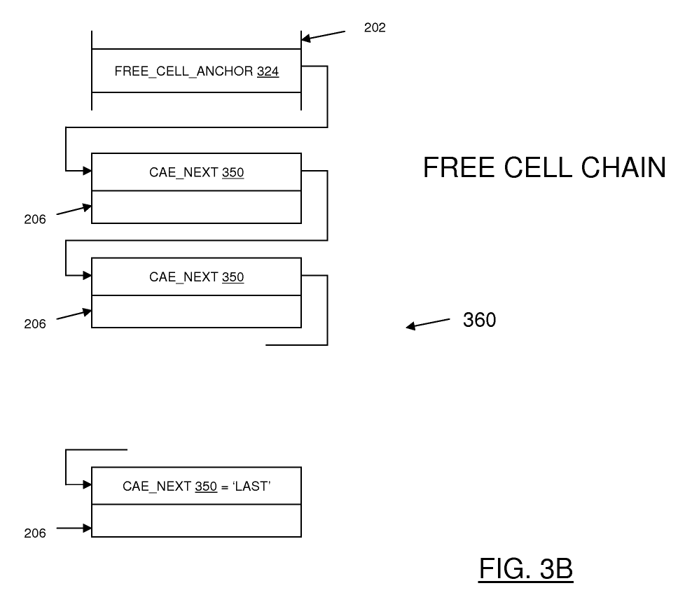

FIG. 2 shows the internal organization of a cell pool extent 200. Cell pool extent 200 contains a cell pool header 202, shown in more detail in FIG. 3A. Each cell pool extent 200 has a fixed size, regardless of the cell sizes supported in the extent. In addition, the extent 200 is allocated on a predictable boundary. The implementation shown is based on an extent size of 1 megabyte (MB) allocated on a 1 MB boundary. Extent 200 is allocated on a predictable boundary because a free operation on a cell will cause the service to round the cell address to the predictable boundary in order to locate the cell pool header 202.

Following the cell pool header 202 are a control array 204 with control array elements 206 (CA(1), CA(2), . . . , CA(N)) and a cell array 209 with cells 210 (CELL(1), CELL(2), . . . , CELL(N)). Cell array 209 can follow immediately after the control array 204 or can be aligned to an optimum boundary to reduce cache misses and page faults. In a preferred embodiment, the first cell 210 is aligned to a page boundary of 4096 bytes (4 KB). Each control array element 206 corresponds to a single cell 210, with the last control array element 208 corresponding to the last cell 212. Given an address of a cell 210, one can locate the pool header 202 by rounding down to the previous 1 MB boundary. Then, using the information in the pool header 202 (shown in FIG. 3A and described below), one can calculate the index for the cell 210 in the cell array 209. This same index can then be used to access the appropriate control array element 206 corresponding to the cell 210 in the control array 204. In most other cell pool arrangements, by contrast, freeing a cell requires more information than the cell address, such as the address of the pool header 202 or a cell size.

FIG. 3A shows the contents of the pool header 202 and the contents of a control array element 206. The contents of the pool header 202 will first be described.

Eye catcher 304 is a text string used to identify this 1 MB extent of storage as a cell pool extent 200. It is used to verify that a request to get or free a virtual address does reference storage residing in a cell pool. This is used to prevent the cell pool services 22 from modifying storage that is not part of a cell pool extent 200.

Storage attributes 306 are stored so that any future need to expand the cell pool can obtain additional system storage for a new extent 200, with the same storage attributes as the initial extent. On operating systems such as the IBM z/OS operating system, storage attributes are things like private or common, fetch protected or not fetch protected, pageable or page fixed, and storage keys 0-15. Not all operating systems support these attributes; instead, they may have other attributes such as user storage and kernel storage.

CA_SPACE 308 is the number of bytes needed for the pool header 202 and the control array 204. When building a new extent 200, the CA_SPACE 308 value added to the base address of the new extent provides the address of the first cell 210 in the new extent.

CAE_SIZE 310 is the size of a single control array element 206. It is possible to use the control array element 206 to store assorted serviceability data 352 to assist in debugging problems. The more data placed in the control array element 206, the larger the size 310. CAE_SIZE 310 is used to calculate the amount of space 308 (CA_SPACE) that the control array 204 is going to consume.

@MAIN_POOL_HEADER 312 is the address of the pool header 202 for the initial extent in a given cell pool. The management of the free chain (FIG. 3B) and the active extent is performed from the initial extent 200. When a cell 210 is freed, the FREE CELL service 700 (FIG. 7) locates the pool header 202 for the extent 200 containing the cell and then uses @MAIN_POOL_HEADER 312 to locate the initial extent for this pool.

The requested cell size passed as input 402 (FIG. 4) contains the minimum-size cell required by the caller. The BUILD POOL service 400 (FIG. 4) may round the cell size up to a higher value to optimize the alignment of cells on cache line or page boundaries. This rounded value is stored in CELLSIZE 314. CELLSIZE 314 is used in the calculations to verify that the cell address passed in on a FREE CELL call is on an appropriate boundary as well as to determine the index into the control array 204.

HIGH_INDEX 316 contains the index value for the last cell 212 in the extent. HIGH_INDEX 316 is used during processing of the GET CELL service 500 (FIG. 5) to detect when one is using the last cell 212 in the extent 200. At that point, the atomic swap operation will modify HWM_ANCHOR 328 (described below) to indicate that all cells 210 in this extent 200 are exhausted.

@CONTROL_ARRAY 318 contains the address of the control array 204.

@CELL_ARRAY 320 contains the address of the first cell 210 in an extent 200.

@NEXT_EXTENT 322 contains the address of the next extent 200. Extents 200 are chained for diagnostic purposes.

FREE_CELL_ANCHOR 324 contains the address of the control array element 206 for the first free cell 210 on the free chain. As cells 210 are freed, an atomic swap operation is used to change FREE_CELL_ANCHOR 324 to point to the control array element 206 for the cell being freed. CAE_NEXT 350 (described below) for the cell being freed is set to FREE_CELL_ANCHOR 324 prior to the swap operation.

FREE_CELL_SEQNUM 326 is a sequence number used in a compare-and-swap operation in conjunction with FREE_CELL_ANCHOR 324. For each update to FREE_CELL_ANCHOR 324, FREE_CELL_SEQNUM 326 is incremented by 1. This is standard chaining behavior to prevent damage to the chain.

HWM_ANCHOR 328 contains the address of the control array element 206 that represents the next free cell 210 to be handed out when FREE_CELL_ANCHOR 324 indicates that the free chain (FIG. 3B) is empty.

HWM_SEQNUM 330 is a sequence number used in a compare-and-swap operation in conjunction with HWM_ANCHOR 328. For each update to HWM_ANCHOR 328, HWM_SEQNUM 330 is incremented by 1. This is standard chaining behavior to prevent damage to the chain (FIG. 3B).

The contents of the control array element 206 will next be described. In control array element 206, a CAE_NEXT 350 field is used to keep track of the corresponding cell 210 in the extent 200. The CAE_NEXT 350 field can have the following values:

| | |
|---|---|
| Zero | When this field is zero, it means the cell which |
| | this control array element represents has never |
| | been used. |
| x′00000000 80000000′ | This is a reserved value (shown here as a |
| | hexadecimal) to indicate that this is the last |
| | control array element 350 on the free chain (FIG. |
| | 3B) anchored by FREE_CELL_ANCHOR 324. |
| Address with low | This means that the cell is in use. The address |
| bit one. | saved in the CAE_NEXT 350 field is the return |
| | address of the code which did the cell pool get |
| | call. This provides some serviceability |
| | information if a problem occurs. |
| Address with low | This means that the cell is on the free chain (FIG. |
| bit zero. | 3B) and the address points to the next control |
| | array element 206 on the free chain. |

FIG. 3B shows a free cell chain 360, composed of one or more control array elements 206 corresponding to cells 210 that have been returned by a requester 24 after they have been used. As shown in the figure, the FREE_CELL_ANCHOR field 324 of the pool header 202 points to the first such control array element 206 in the chain 360, while the CAE_NEXT field 350 of each control array element 206 except for the last points to the next control array element in the chain 360. The last such control array element 206 has its CAE_NEXT field 350 set to the reserved value (x′00000000 80000000′, signified by “LAST” in FIG. 3B) to indicate that it is the last element in the chain. The uppermost control array element 206 shown in FIG. 3B thus corresponds to the head of the chain 360, from which elements are removed and to which they are added, while the lowermost control array element 206 shown in FIG. 3B corresponds to the end of the chain.

FIG. 4 shows the processing that occurs in the BUILD POOL service 400 when a new cell pool is constructed. The caller of the BUILD POOL service 400 (i.e., a requester 24) passes in parameters 402. These parameters 402 include the desired cell size and the desired storage attributes 306. Although there are many possible storage attributes, they are not critical to this invention. Whether the storage is pageable or page fixed does not affect the algorithm of the present invention. The storage attributes 306 are only used when obtaining an initial or secondary extent 200.

The service 400 starts out by allocating an initial extent 200 for the cell pool (step 404). In the embodiment shown, the extent size is always 1 MB. The extent size is not critical, however, and it is possible to use other extent sizes as long as the same extent size is used for all pools. This allows the pool header 202 to be located, given a cell address 210, by rounding the address down to the boundary represented by the extent size.

Next the service 400 calculates the number of cells 210 of the requested CELLSIZE 314 which can fit in an extent 200 (step 406). This calculation takes into account the size of the pool header 202, the size of the control array 204 and the alignment of the first cell 210 on a page boundary. If one wishes to have things like a guard page at the beginning or end of the extent, this is also taken into account. The service 400 first calculates the maximum number of cells that could be supported if no space was wasted between the last control array element 208 and the first cell 210:

#CELLS=(ExtentSize−Size(pool header))/(CELLSIZE+Size(control array element))

The fields in the pool header 202 are filled in as they are calculated (step 408).

Using #CELLS as a starting point, the service 400 then calculates CA_SPACE 308 as follows:

CA_SPACE=Size(pool header)+(#CELLS*Size(control array element))

CA_SPACE is then rounded to a multiple of 4096 bytes (4 KB) to make sure CELL(1) 210 is on a page boundary.

The service 400 now recalculates #CELLS as follows:

#CELLS=(ExtentSize−CA_SPACE)/CELLSIZE

The service 400 then sets @CELL_ARRAY 320 as follows:

@CELL_ARRAY=Address of extent+CA_SPACE

It also sets @CONTROL_ARRAY 318 as follows:

@CONTROL_ARRAY=Address of extent+Size(pool header)

The following fields in the pool header 202 are set as well:
1. Eye catcher 304 is set to a character string used in future validity checking.
2. Storage attributes 306 are set from the input parameters 402.
3. CAE_SIZE 310 is set to the size of the control array elements 206. The minimum size for CAE_SIZE 310 is the size of a pointer. This would be 4 bytes for 32-bit addressing or 8 bytes for 64-bit addressing. If additional serviceability data 352 is desired in the control array elements 206, then CAE_SIZE 310 would account for this additional information.
4. When the first extent 200 is created, @MAIN_POOL_HEADER 312 is set. When secondary extents 200 are created, the pool header 202 is partially copied to the new extents 200, which will propagate MAIN_POOL_HEADER 312 to the new extent.
5. HIGH_INDEX 316 is set to #CELLS−1, since the control array 204 and the cell array 209 are zero-based arrays.
6. FREE_CELL_ANCHOR 324 is set to a reserved value that indicates the free chain 360 is empty. The embodiment shown uses value x′00000000 800000000′for a 64-bit implementation.
7. FREE_CELL_SEQNUM 326 is initialized to zero.
8. HWM_ANCHOR 328 is set to point to the address of the first control array element 206.
9. HWM_SEQNUM 326 is initialized to zero.

When all the fields are successfully filled in, the address of the pool header 202 is returned to the caller (step 410).

FIG. 5 shows the logic of the GET CELL service 500.

The caller of the GET CELL service 500 (i.e., a requester 24) passes in the address of the pool header 202 as an input parameter (step 502). The input parameter is verified to be on an appropriate boundary (e.g., 1 MB) and have the expected eye catcher 304 at the start of the pool header 202 (step 504). If the input parameter 502 fails this validity check, an error is returned to the caller (step 506).

Otherwise, FREE_CELL_ANCHOR 324 is examined to see if there are any free cells on the free chain 360 (step 508). If FREE_CELL_ANCHOR 324 does not equal the reserved empty chain value, an attempt is made to compare and swap the top element off the chain 360 (step 510). This is accomplished with the logic of the following pseudocode (in which the symbol “|” denotes the concatenation of elements):

OLD_FREE_CELL_ANCHOR = FREE_CELL_ANCHOR
OLD_FREE_CELL_SEQNUM = FREE_CELL_SEQNUM
NEW_FREE_CELL_ANCHOR = CAE_NEXT of control
array element pointed to by OLD_FREE_CELL_ANCHOR
NEW_FREE_CELL_SEQNUM = OLD_FREE_CELL_SEQNUM + 1

Compare and swap OLD_FREE_CELL_ANCHOR|OLD_FREE_CELL_SEQNUM with NEW_FREE_CELL_ANCHOR|NEW_FREE_CELL_SEQNUM in the fields FREE_CELL_ANCHOR|FREE_CELL_SEQNUM

In the above compare-and-swap operation, the current value of FREE_CELL_ANCHOR|FREE_CELL_SEQNUM is compared with the previous value as represented by OLD_FREE_CELL_ANCHOR|OLD_FREE_CELL_SEQNUM. If the previous value of FREE_CELL_ANCHOR|FREE_CELL_SEQNUM has not changed since it was captured, then the comparison was successful, FREE_CELL_ANCHOR|FREE_CELL_SEQNUM is replaced with NEW_FREE_CELL_ANCHOR|NEW_FREE_CELL_SEQNUM as part of the same atomic operation, and control flows to step 526, described below; if the comparison fails, then the logic loops back to step 508 to reexamine the free chain 360 (step 512).

Step 510 and other atomic compare-and-swap operations described herein are preferably performed using an atomic CPU instruction such as the CDSG (Compare Double and Swap) instruction of the z/Architecture. Using such an atomic instruction ensures that the fields being compared are not updated by other requesters between the comparison and update phases of the operation.

If the examination of the free chain 360 at step 508 shows that the free chain 360 is empty (FREE_CELL_ANCHOR 324 has a value of x′00000000 800000000′), then the service 500 proceeds to examine the high water mark (step 514). If HWM_ANCHOR 328 is not zero, then the service 500 attempts to move the high water mark (HWM) to the next control array element (step 510). The logic below accomplishes this:
OLD_HWM_ANCHOR=HWM_ANCHOR
OLD_HWM_SEQNUM=HWM_SEQNUM

The service 500 figures out the pool extent 200 that OLD_HWM_ANCHOR points to by rounding down to a 1 MB boundary, which will be called @CURR_PH. Using @CONTROL_ARRAY 318 from the pool extent 200 corresponding @CURR_PH, the service 500 calculates the index value for this control array element 206. If this index value is equal to HIGH_INDEX 316, then this is the last available element 208 in this extent 200. In that case, it sets
OLD_HWM_ANCHOR=0.

If it wasn't the last element, then it sets

NEW_HWM_ANCHOR=OLD_HWM_ANCHOR+CAE_SIZE,

which moves the high water mark to the next control array element. The service then sets

NEW_HWM_SEQNUM=OLD_HWM_SEQNUM+1

and performs the following compare-and-swap operation:
Compare and swap OLD_HWM_ANCHOR|OLD_HWM_SEQNUM with NEW_HWM_ANCHOR|NEW_HWM_SEQNUM in the fields HWM_ANCHOR|HWM_SEQNUM

The semantics and atomicity of this compare-and-swap operation are similar to those of the compare-and-swap operation of steps 510-512 described above. If the original contents of HWM_ANCHOR|HWM_SEQNUM have not changed since they were captured, then the comparison was successful (step 518), HWM_ANCHOR|HWM_SEQNUM is replaced with NEW_HWM_ANCHOR|NEW_HWM_SEQNUM, and control flows to step 526, which will be described later. If the comparison fails at step 518, then the logic loops back to step 514 to reexamine the high water mark.

If the examination of the high water mark at step 514 shows that the extent is exhausted, the service 500 proceeds to call (step 520) the expand pool routine 600, which is described in FIG. 6. If the expand is successful (step 522), then the service 500 loops back to step 508 and starts over. If the expand failed, then the service 500 returns (step 524) an error to the caller.

If the service 500 succeeded in getting a cell either from the free chain 360 or by advancing the high water mark, it sets (step 526) the CAE_NEXT field 350 in the control array element 206 for the cell it just obtained to the return address of the caller of the GET CELL service with the low-order bit turned on. This marks the cell as in-use. Any serviceability information is stored in the CAE_DIAG_DATA field 352. The cell address is returned to the caller.

FIG. 6 shows the EXPAND POOL routine 600, which is called at step 520 by the GET CELL service 500 when there are no available free cells in the pool. The only input 602 to the EXPAND POOL routine 600 is the address of the cell header 202 of the primary extent 200 of the cell pool. Using the storage attributes 306 from the pool header 202, a new extent (1 MB) is obtained (step 604). If the allocation fails (step 606), then an error is returned to the caller (step 608). If the allocation succeeds at step 606, then the pool header 202 from the initial extent 200 is copied to the new extent, thereby priming most of the cell header fields (step 610). @CONTROL_ARRAY 318 and @CELL_ARRAY 320 are set for this extent using the same logic that was used to set them in the initial extent. FREE_CELL_ANCHOR 324 and HWM_ANCHOR 328 and their corresponding sequence numbers are unused in secondary extents, so their contents are irrelevant.

Once the new extent initialization is complete, the routine 600 attempts to swap the address of the new extent into HWM_ANCHOR 328 of the original extent 202 while incrementing HWM_SEQNUM 330 (step 614). If the swap is successful (step 616), the routine 600 chains the new extent to the initial extent at field @NEXT_EXTENT 322 using a compare-and-swap operation (step 619) and then returns success to the caller (step 620). If the swap fails at step 616, it is because some other unit of work was also in the process of expanding the pool and completed the swap before this instance of the expand routine 600. Since a new extent is now available, the routine 600 deletes the extent it has just prepared (step 618) and then returns success (step 620) to the caller. The caller does not care whether it or some other work unit expanded the pool.

FIG. 7 shows the FREE CELL service 700. The caller of the FREE CELL service 700 passes in the address of the cell 210 to be freed as an input parameter 702.

The address 702 of the cell is first rounded down to the 1 MB extent boundary (step 704). The input parameter 702 is then verified as follows (step 706). The eye catcher 304 of the pool header 202 is first verified to validate that the cell is in a cell pool. Using @CELL_ARRAY 320 and CELLSIZE 314, the service 700 then verifies that the cell address 702 is on a valid cell boundary in this extent and calculates the index into the cell array 209 for the cell 208. This is the same is the index into the control array 204 for the control area element 206.

If the cell address 702 is valid and, using the calculated index, the CAE_NEXT 350 field for this cell indicates that the cell is currently allocated (step 708), then the service proceeds to free the cell. If at step 708 there are any problems with the cell being freed, an error is returned to the caller (step 718).

The setup for the swap operation to be described is as follows:
OLD_ANCHOR=FREE_CELL_ANCHOR
OLD_SEQNUM=FREE_CELL_SEQNUM
NEW_ANCHOR=Address of cell being freed

NEW_SEQNUM=OLD_SEQNUM+1

The CAE_NEXT 350 field for this cell is set to OLD_ANCHOR 324 as we will be attempting to place this newly freed cell as the new anchor to the free chain.

The atomic swap operation (step 712) compares FREE_CELL_ANCHOR 324|FREE_CELL_SEQNUM 326 to OLD_ANCHOR|OLD_SEQNUM and, if they are equal, sets FREE_CELL_ANCHOR 324 to NEW_ANCHOR and FREE_CELL_SEQNUM 326 to NEW_SEQNUM.

If the swap completed successfully (step 714), we return success (step 716) to the caller. If the swap did not complete successfully 714, it is because some other work unit has either obtained a cell from the free chain 360 or freed another cell, after this instance of the free cell service 700 saved the OLD_ANCHOR|OLD_SEQNUM. We go back to step 710 to repeat the process of adding the free cell to the head of the free chain 360.

This completes the description of get and free operations against a cell pool with a single-size cell. The following text describes how one can use this same cell pool processing to satisfy variable-size storage requests against storage with different attributes. On a z/OS operating system, the attributes supported may include, without limitation, the following: (1) common or private storage; (2) fetch-protected storage or not fetch-protected storage; (3) pageable, disabled reference (DREF) or page fixed; and (4) storage key 0-15. An example of an attribute set would be common, fetch-protected, pageable, key 2 storage. On other operating systems where storage keys are not supported, attributes may include, without limitation, the following: (1) pageable or page fixed; (2) user private storage or kernel storage; and (3) any other storage attribute

FIG. 8 shows the layout of control blocks that could be used to satisfy a variable-size request for storage with different storage attributes.

There are two arrays to describe in addition to the arrays previously described that are part of a cell pool. The first array 804 is an array of attribute sets. Each entry 805 in the array 804 represents a unique set of attributes. The number of entries 805 is dependent on the number of attributes which the system chooses to support and the number of values possible for each attribute. The second array 806 is a cell size array. Each entry 807 in the cell size array 806 contains the cell pool anchor for a cell pool 200. For discussion purposes, assume the cell sizes supported are 64, 128, 256, 512, 1024, 2048, 4096 and 8192 bytes. One can support as many sizes as one wants, as long as at least one cell 210 can be fitted into the pool extent 200. If a request is made for 100 bytes, it will be satisfied by the cell pool with 128 byte cells. Each of the cell pools 200 is managed with the same logic that has previously been described for cell pools for a single size.

If no storage requests are made for a particular attribute set, then the entry 805 for that attribute set, in the attribute array 804, will remain zero. If no storage requests are made within a given size range, then the entry 807 in the size array 806 will remain zero.

The attribute array 804 is anchored at some well-known point 802 in the system. For common storage, there would be a single anchor point 802 for all callers. For private storage, each address space, process or task could have its own anchor point 802.

FIG. 9 shows the logic for the GET STORAGE service 900. The input parameters 902 to the service 900 contain the size and attributes of the storage desired.

The service 900 examines the requested storage attributes 902 and determines which well-known anchor point 802 to use for the request (step 904). The service 900 also uses the requested storage attributes 902 to calculate the index into the attribute set array 804 so that it knows which entry 805 to use. The storage for the attribute set array 804 can be preallocated or it can be allocated when the first request is received. If the attribute set array 804 is not preallocated, then a routine would be needed to get and initialize the storage, which would then use compare and swap logic to make the array active. If it loses the swap race, then it would delete the array it created. This is the same race processing that has been previously described for expanding the cell pools 600 so it will not be described in detail. Similarly, the cell size arrays pointed to by the attribute set entries 805 can either be preallocated or allocated on demand and made active with compare and swap logic.

Step 904 will either locate an existing attribute array 804 or create one and swap it into the well know anchor point 802. The next step is to take the input storage size 902 and determine which entry 807 in the cell size array 806 represents the smallest cell size that will satisfy the current request. If the chosen cell size entry 807 is zero, then call the build pool routine 400 to create a cell pool with the requested storage attributes and cell size desired. Once the cell pool is created, compare and swap logic is used to set the address of the pool header 202 into the cell size array 807. If the compare and swap fails, it is because some other work unit succeeded in creating the pool first. In that case, the storage for the cell pool is deleted. Once the entry 807 in the cell size array 806 points to a cell pool header 202, the service proceeds to call the get cell service 500 to obtain a cell. This request either succeeds or fails and the result is returned to the caller 910.

With all of the services described so far, at no point has any locking been used to serialize the structures. Creation of attribute sets 804, cell size arrays 806, new cell pools 200 or new cell pool extents are infrequent occurrences. If two or more processes attempt to create one of these structures at the same time, they race to make the one they created active with a compare-and-swap operation. The loser of the race then deletes the structure they just created.

While particular embodiments have been shown and described, various modifications and extension will be apparent to those skilled in the art.

What is claimed is:

1. A method for managing virtual storage, comprising:
maintaining a cell pool extent in virtual storage comprising a control array in a first portion thereof and a cell array in a second portion thereof, the cell array comprising one or more cells of available storage, the control array containing one or more control array elements corresponding respectively to the cells, each of the control array elements indicating whether a corresponding cell is currently allocated to a requester; and
in response to a request from a requester to obtain a cell of storage, allocating a cell from the cell array to the requester and updating the corresponding control array element to indicate that the cell is currently allocated to a requester.

2. The method of claim 1, wherein the cell pool extent contains a header with pointers to the control array and to the cell array.

3. The method of claim 1, wherein one or more of the control array elements contain a pointer to a next control array element in a chain of control array elements corresponding to free cells.

4. The method of claim 1, wherein the cell pool extent contains one or more previously unallocated cells and a pointer to one or more free cells that have been returned by requesters, and wherein the step of allocating a cell comprises:
allocating a free cell if one is available, otherwise, allocating a previously unallocated cell.

5. The method of claim 4, wherein the cell pool extent contains a pointer to a control array element corresponding to one of the free cells, and wherein the step of allocating a free cell comprises the step of updating the pointer to point to a control array element corresponding to a next one of the free cells.

6. The method of claim 4, wherein the cell pool extent contains a pointer to a control array element corresponding to one of the previously unallocated cells, and wherein the step of allocating a previously unallocated cell comprises the step of updating the pointer to point to a control array element corresponding to a next one of the previously unallocated cells.

7. The method of claim 1, wherein the step of allocating a cell comprises:
determining whether there are cells available for allocation from the extent; and
creating a new extent and allocating a cell from the new extent if there are no cells available for allocation from a currently active extent.

8. The method of claim 1, wherein the step of allocating a cell is performed using a single atomic instruction.

9. The method of claim 1, further comprising:
in response to a request to return a cell of storage:
examining the corresponding control array element to determine whether the cell is currently allocated to a requester; and
if the control array element indicates that the cell is currently allocated to a requester, returning the cell to the cell array and updating the corresponding control area element to indicate that the cell is not currently allocated to a requester, otherwise, failing the request without updating the corresponding control area element.

10. The method of claim 9, wherein the cell pool extent contains a pointer to a control array element corresponding to one of the free cells, and wherein the step of returning a cell to the array comprises the step of updating the pointer to point to a control array element corresponding to the returned cell.

11. The method of claim 9, wherein the cell pool extent has a base address located at a multiple of a predetermined storage increment, wherein the request to return a cell of storage contains a cell address of a cell be returned, and wherein the examining step comprises:
determining the base address of the cell pool extent from the cell address by rounding the cell address down to a multiple of the storage increment.

12. The method of claim 1, wherein the maintaining step comprises the step of maintaining a plurality of cell pool extents in virtual storage, each cell pool extent having a common size.

13. The method of claim 1, wherein the maintaining step comprises the step of maintaining a plurality of sets of cell pool extents in virtual storage, wherein the cell pool extents in each of the sets contain cells of a given size, and wherein the allocating step comprises allocating a cell of a smallest size sufficient to satisfy the request.

14. Apparatus for managing virtual storage, comprising:
cell pool logic for maintaining a cell pool extent in virtual storage comprising a control array in a first portion thereof and a cell array in a second portion thereof, the cell array comprising one or more cells of available storage, the control array containing one or more control array elements corresponding respectively to the cells, each of the control array elements indicating whether a corresponding cell is currently allocated to a requester; and
get cell logic responsive to a request from a requester to obtain a cell of storage for allocating a cell from the cell array to the requester and updating the corresponding control array element to indicate that the cell is currently allocated to a requester.

15. The apparatus of claim 14, further comprising:
free cell logic responsive to a request to return a cell of storage for:
examining the corresponding control array element to determine whether the cell is currently allocated to a requester; and
if the control array element indicates that the cell is currently allocated to a requester, returning the cell to the cell array and updating the corresponding control area element to indicate that the cell is not currently allocated to a requester, otherwise, failing the request without updating the corresponding control area element.

16. The apparatus of claim 15, wherein the cell pool extent has a base address located at a multiple of a predetermined storage increment, wherein the request to return a cell of storage contains a cell address of a cell be returned, and wherein the free cell logic determines the base address of the cell pool extent from the cell address by rounding the cell address down to a multiple of the storage increment.

17. The apparatus of claim 14, wherein the cell pool logic maintains a plurality of cell pool extents in virtual storage, each cell pool extent having a common size.

18. The apparatus of claim 14, wherein the cell pool logic maintains a plurality of sets of cell pool extents in virtual storage, wherein the cell pool extents in each of the sets contain cells of a given size, and wherein the allocating and updating means allocates a cell of a smallest size sufficient to satisfy the request.

19. A computer program product stored on a computer-usable medium for managing virtual storage, comprising a computer-readable program for causing a computer to perform the following method steps when the program is run on the computer:
maintaining a cell pool extent in virtual storage comprising a control array in a first portion thereof and a cell array in a second portion thereof, the cell array comprising one or more cells of available storage, the control array containing one or more control array elements corresponding respectively to the cells, each of the control array elements indicating whether a corresponding cell is currently allocated to a requester; and
in response to a request from a requester to obtain a cell of storage, allocating a cell from the cell array to the requester and updating the corresponding control array element to indicate that the cell is currently allocated to a requester.

20. The computer program product of claim 19, wherein the method steps further comprise:
in response to a request to return a cell of storage:
examining the corresponding control array element to determine whether the cell is currently allocated to a requester; and
if the control array element indicates that the cell is currently allocated to a requester, returning the cell to the cell array and updating the corresponding control area element to indicate that the cell is not currently allocated to a requester, otherwise, failing the request without updating the corresponding control area element.

21. The computer program product of claim 20, wherein the cell pool extent has a base address located at a multiple of a predetermined storage increment, wherein the request to return a cell of storage contains a cell address of a cell be returned, and wherein the examining step comprises:
determining the base address of the cell pool extent from the cell address by rounding the cell address down to a multiple of the storage increment.

22. The computer program product of claim 19, wherein the maintaining step comprises the step of maintaining a plurality of cell pool extents in virtual storage, each cell pool extent having a common size.

23. The computer program product of claim 19, wherein the maintaining step comprises the step of maintaining a plurality of sets of cell pool extents in virtual storage, wherein the cell pool extents in each of the sets contain cells of a given size, and wherein the allocating step comprises allocating a cell of a smallest size sufficient to satisfy the request.
